(19) United States
(12) Patent Application Publication
(10) Pub. No.: US 2014/0250825 A1
(43) Pub. Date: Sep. 11, 2014

(54) CAST-IN ANCHOR SYSTEM

(71) Applicant: DOUGLAS S. RICHARDSON, SPRING BRANCH, TX (US)

(72) Inventor: DOUGLAS S. RICHARDSON, SPRING BRANCH, TX (US)

(21) Appl. No.: 13/794,324

(22) Filed: Mar. 11, 2013

(51) Int. Cl. E04B 1/41; F16B 41/00

(52) U.S. Cl. CPC E04B 1/4107; F16B 41/002
USPC 52/710; 411/81; 29/428

(57) ABSTRACT

A cast-in anchor system for anchoring objects to concrete structures. The preferred system uses an extruded cast-in anchor and an extruded bolt retainer. The cast-in anchor is embedded within concrete with a face left exposed. The bolt retainer has a bolt inserted through it and is placed within an anchor channel on the exposed face of the cast-in anchor. The bolt retainer allows for use of an industry-standard bolt and prevents the bolt from rotating once the bolt-head is seated against it. The cast-in anchor and the bolt are positioned along the length of the anchor channel, with a threaded portion of the bolt extending out of the anchor channel. A workpiece is placed over the threaded portion of the bolt and a nut is tightened. Tightening the nut causes locking surfaces on the bolt retainer to engage with corresponding surfaces on the anchor channel which prevents the bolt retainer from exiting the anchor channel.

### BACKGROUND OF THE INVENTION

1. Field of the Invention

The present invention relates generally to improved concrete cast-in anchor systems and improved methods of manufacturing of the various components of these systems. More specifically, the preferred embodiment of the present invention relates to a cast-in anchor system partially made of extruded components and which allows for use of industry-standard bolts to operate the system, rather than specialty bolts.

2. Description of the Related Art

Cast-in anchor systems are one of a variety of ways to anchor objects to concrete structures. These systems are particularly advantageous because they provide diverse anchoring solutions, able to anchor many different items. For example, these systems may be used to anchor heavy equipment within a building or curtain wall systems to the exterior of a building.

In general, traditional cast-in anchor systems use an embedded cast-in anchor engaged with one or more retaining bolt(s). The cast-in anchor is a pre-fabricated length of material with an anchor channel extending along one side. The one or more retaining bolts insert into the anchor channel and extend away from the concrete structure as further explained below.

During construction of a concrete structure the cast-in anchor is positioned for its eventual embedment in the concrete. Typically, one or more headed studs extend into the concrete structure from a side of the cast-in anchor opposite the anchor channel. The cast-in anchor may be affixed to internal supports, such as reinforcing steel or other support members, by wire tying the headed studs to the internal supports. Alternatively, the cast-in anchor may be somehow fastened to the concrete form such as, for example, by using nails, screws or other suitable fasteners. As concrete is poured into the form, the cast-in anchor and any headed studs extending therefrom are surrounded by the concrete.

At least one face of the cast-in anchor is not surrounded by the concrete and is left exposed. The exposed face allows access to the anchor channel after the concrete hardens. The anchor channel has an anchor-channel interior defined by anchor-channel sidewalls. Retaining lips extend from the anchor-channel sidewalls into the anchor-channel interior, leaving an anchor-channel opening between the lips.

One or more retaining bolts is inserted into the anchor-channel interior to anchor an object. Typically the retaining bolts are “specially bolts” generally shaped like the letter “T.” These heads of the so called “t-bolts forms the arms of the “T” and the threaded portion of the a bolt is along the vertical “leg” of the “T”. The bolt is inserted by aligning the head of the bolt so the arms of the “T” can be inserted through the anchor-channel opening between the retaining lips. In this position, the head of the bolt is inserted into the anchor-channel interior while the threaded portion of the bolt remains at least partially out of the anchor-channel interior.

Once the bolt-head is within the anchor-channel interior, the bolt is rotated about its vertical axis until the arms of the “T” are transverse to the channel opening. The T-bolt is positioned in its desired location along the anchor channel and initially pulled against the retaining lips with one hand so that it remains in place. While keeping this initial tension on the bolt with one hand, the object to be anchored is placed over the threaded portion of the bolt and held in place for anchoring. Meanwhile, a nut must be threaded onto the threaded portion of the bolt with the other hand and torque applied to tighten the connection. At some point, the connection is tight enough so that the user can stop pulling the bolt against the retaining lips and the connection may be finally tightened to anchor the object to the concrete. Initially, however, the installation process is difficult and awkward due to the variety forces a user must apply in operating the system to tighten the connection.

Traditional cast-in anchor systems have certain disadvantages. For example, the cast-in anchor is made from steel and manufactured through cumbersome and costly manufacturing processes such as hot or cold rolling steel, rather than less cumbersome and less costly extrusion processes. Additionally, the specialty T-bolts of traditional cast-in anchor systems cost more than industry standard bolts and may not be readily available to end users. The bolts are also awkward to install, requiring two hands moving in a variety of directions as described above.

It is therefore desirable to provide a cast-in channel anchoring system which can be manufactured through less costly extrusion techniques and which uses industry standard bolts instead of specialty fasteners such as the T-bolt. Additionally, it is desirable to provide a cast-in anchor system which allows for less awkward operation.

### BRIEF SUMMARY OF THE INVENTION

The improved cast-in anchor system of the present invention provides the advantage of less costly extrusion manufacturing techniques. It also offers a bolt retainer used in combination with standard metric or English bolts to anchor objects, rather than specialty retaining bolts. Finally, the preferred embodiment of the present invention provides for more efficient, less awkward operation.

The present invention has a cast-in anchor and bolt retainer which are both preferably created through metal extrusion processes. In this regard, a suitable metal or metal alloy is heated until the material is pliable enough to pass through a die. The die gives these items their profile shapes as the heated material passes through and the resulting shapes are typically presented in long lengths of material with a uniform profile throughout. The long lengths of material are then cut to desired lengths and further shaped and processed as described herein below.

Aluminum alloy is the preferred material for the cast-in anchor and bolt retainer. Aluminum′ however, is generally disfavored as a material for use in reinforced concrete because aluminum which comes into electrical contact with reinforcing steel has been shown to undergo galvanic corrosion due to the different electrode potentials of the dissimilar metals. Studies have shown that such galvanic corrosion weakens both the structure of the aluminum and the surrounding concrete. The present invention accounts for this problem as detailed herein below.

The cast-in anchor has an anchor channel on one side and a plate channel on another side. The anchor channel also has retaining lips and serves a similar purpose as traditional cast-in anchors. The plate channel, however, serves an entirely new purpose. It has a plate-channel interior for receiving and holding a base plate which has one or more headed studs extending from it. The base plate and the headed stud(s) are preferably made from steel and are welded together to form a base assembly. The base assembly combined with the cast-in anchor forms a cast-in anchor assembly. The cast-in anchor assembly is embedded into the concrete structure.

In the preferred embodiment, the base assembly is hot-dip galvanized prior to insertion of the base plate into the plate-channel interior. Galvanizing helps prevents electrical contact between the aluminum-based cast-in anchor and the steel base assembly, thereby reducing the possibility of galvanic corrosion between the dissimilar material.

Additionally, the cast-in anchor assembly is coated with a suitable preventive coating to provide a barrier against water. Water is present in wet concrete and could serve as an electrolyte to promote galvanic corrosion. Without the coating, galvanic corrosion could occur between the preferred cast-in anchor and reinforcing steel within the concrete structure. The coating is not necessary and is not desired within the anchor-channel interior, however, and it is shielded against receiving the coating during the manufacturing process.

The preferred bolt retainer is also extruded, cut to length and undergoes further manufacturing processes to prevent galvanic corrosion. When the processes are complete, an industry standard bolt can be inserted into a bolt-hole in the bolt retainer. Leading with its threaded portion, the bolt is inserted into the bolt-hole until the head of the bolt (hereinafter “bolt-head”) contacts a bearing surface on the bolt retainer. Once fully inserted, one or more side surfaces of the bolt-head are adjacent one or more bolt-lock tabs extending from the bolt retainer. The bolt-lock tabs prevent the bolt from rotating about its vertical axis when a nut is threaded onto it and the connection is tightened. Together, the bolt retainer and the bolt form the bolt-retainer assembly.

The bolt-retainer assembly is placed into the anchor-channel interior, preferably through an entry point in the retaining lips of the cast-in anchor. Once in the anchor-channel interior, the bolt-retainer assembly is longitudinally displaceable along the length of the anchor channel while the threaded portion of the bolt remains at least partially out of the anchor-channel interior, extending through an opening between the retaining lips. As detailed herein below, the preferred bolt retainer allows a user to remove his/her hand from the bolt-retainer assembly and no initial tension is required to hold the bolt-retainer assembly in its desired location in the anchor channel prior to tightening the connection.

With the bolt-retainer assembly in place, an object is placed over the threaded portion of the bolt. A washer and nut are placed on the bolt and the nut is tightened to secure the connection. As the nut is tightened, the bolt-head exerts force on the bearing surface of the bolt retainer and pulls the bolt retainer toward the opening of the anchor-channel interior. The bolt retainer, however, has one or more locking surfaces which engage against the retaining lips of the anchor channel, thereby preventing the bolt retainer from exiting the anchor-channel interior. With the bolt retainer prevented from exiting the anchor-channel interior the connection may be tightened and the object is anchored to the concrete structure.

### BRIEF DESCRIPTION OF THE DRAWINGS

FIG. 1 is a top perspective view of the preferred cast-in anchor system, showing two bolt-retainer assemblies within an anchor channel along a first side of a cast-in anchor assembly and with a portion of the cast-in anchor assembly removed for illustration purposes.

FIG. 2 is a partially exploded, bottom perspective view of the preferred cast-in anchor system, showing two bolt-retainer assemblies removed from the anchor channel and with a portion of the cast-in anchor assembly removed for illustration purposes.

FIG. 3 is an end view of the preferred cast-in anchor of the present invention showing the cross-sectional profile of the cast-in anchor and with dotted lines to illustrate differing portions of the cast-in anchor.

FIG. 4 is a cross-sectional perspective view of the preferred cast-in anchor of the present invention, showing its cross-sectional profile along the portion of the cast-in anchor assembly which was removed in FIG. 1 and with the base assembly removed.

FIG. 5 is an end plan view of a preferred bolt retainer showing a bolt-hole in the bolt retainer extending along an axis x and with angle lines extending from various surfaces of the bolt retainer for illustration purposes.

FIG. 5A is top perspective view of the preferred bolt retainer shown in FIG. 5 with plane ab extended through axis x and bisecting the bolt retainer for illustration purposes.

FIG. 5B is bottom perspective view of the preferred bolt retainer shown in FIG. 5 showing bolt-lock tabs extending from a first side of the bolt retainer.

FIG. 6 is a side plan view of an industry standard bolt seated in the bolt retainer to form the preferred bolt-retainer assembly and shows a washer and nut threaded onto the bolt.

FIG. 7 is a bottom plan view of the bolt-retainer assembly shown in FIG. 6 and illustrates a bolt-head of the bolt within bolt-lock tabs on the first side of the bolt retainer.

FIG. 8 is a top plan view of the bolt-retainer assembly shown in FIG. 6 which illustrates the washer and nut above a second side of the bolt retainer, with shading lines to indicate angled surfaces on the second side of the bolt retainer.

FIG. 9 is an end plan view of an alternative bolt retainer showing the bolt-hole in the bolt retainer extending along axis x and with angle lines extending from various surfaces of the bolt retainer for illustration purposes.

FIG. 9A is top perspective view of the bolt retainer shown in FIG. 9 with plane ab extended through axis x and bisecting the bolt retainer for illustration purposes.

FIG. 9B is bottom perspective view of the bolt retainer shown in FIG. 9 showing bolt-lock tabs extending from the first side of the bolt retainer.

FIG. 10 is a top plan view of the preferred cast-in anchor system embedded in concrete.

FIG. 11 is a side plan view of the preferred cast-in anchor system embedded in concrete with portions of the cast-in anchor removed for illustration purposes.

FIG. 12 is a cross-sectional side view of the preferred cast-in anchor system embedded within concrete taken along section line 12-12 from FIG. 11 with a workpiece added for illustration, prior to tightening the nut and washer against the workpiece.

FIG. 13 is a cross-sectional side view of the preferred cast-in anchor system embedded within concrete which is taken along section line 12-12 from FIG. 11 with a workpiece added for illustration, after tightening the nut and washer against the workpiece.

FIG. 14 is an exploded, top perspective view of a portion of the preferred cast-in anchor system, showing the bolt-retainer assembly exploded and other portions of the system during the assembly process.

FIG. 15 is a top perspective view of the preferred cast-in anchor assembly showing a shielding tape being applied to a face of the cast-in anchor during the manufacturing process.

FIG. 16 is a bottom perspective view of the preferred cast-in anchor assembly receiving a coating applied during the manufacturing process.

### DETAILED DESCRIPTION OF THE INVENTION

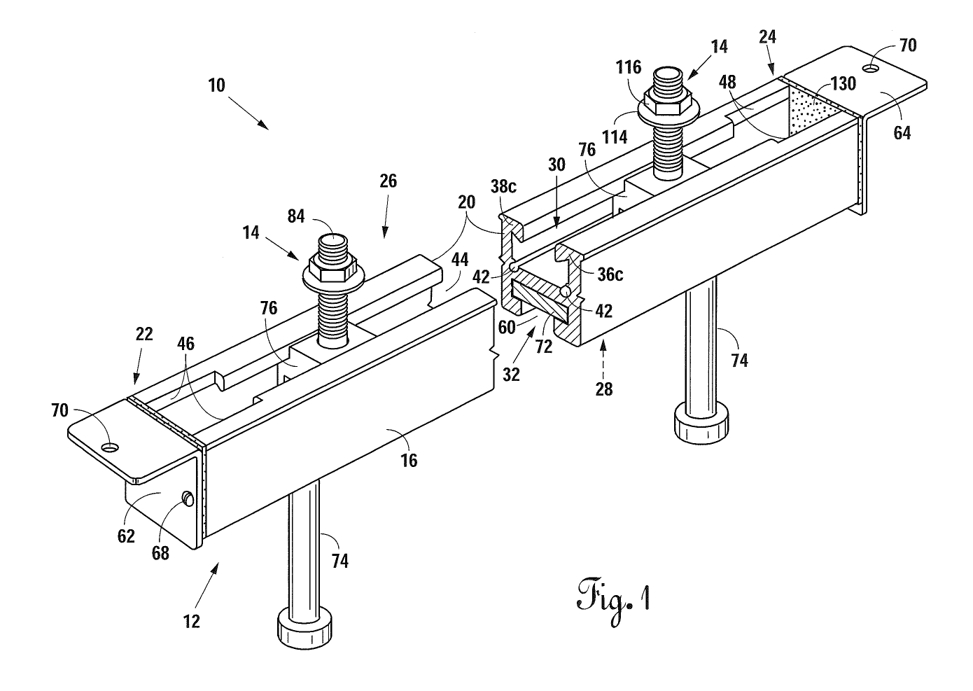

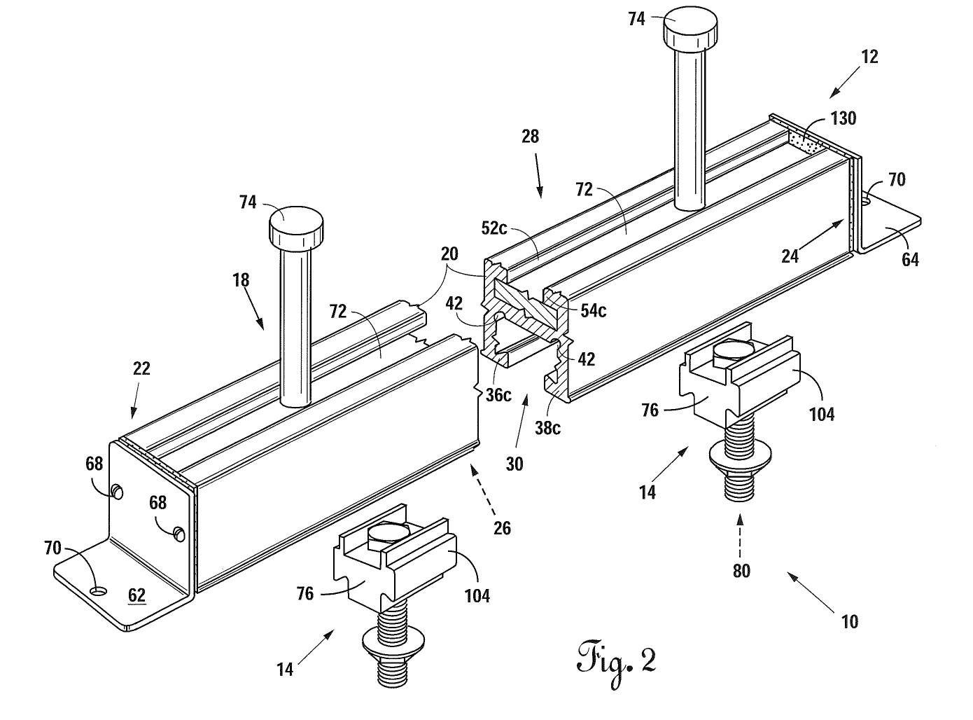

Referring to FIGS. 1 and 2, perspective views of the preferred embodiment of a cast-in anchor system 10 of the present invention are shown. In general, the cast-in anchor system 10 has a cast-in anchor assembly 12 engaged with one or more bolt-retainer assemblies 14. The cast-in anchor assembly 12 and the bolt-retainer assembly 14 each have various components and are individually discussed herein below.

The cast-in anchor assembly 12 has a cast-in anchor 16 attached to a base assembly 18. The cast-in anchor 16 is a length of material 20 extending from a first end 22 to a second end 24. Although the preferred length of material 20 is an extruded aluminum alloy, it could be made from any number of materials, whether extruded or not. The length of material 20 has a first side 26 and a second side 28 separate from the first side 26. An anchor channel 30 extends at least partially along its first side 26 and a plate channel 32 extends at least partially along its second side 28. Preferably, first side 26 and second side 28 are on opposite sides of the length of material 20 though they do not have to be. Further, the anchor channel 30 and the plate channel 32 both preferably extend from the first end 22 to the second end 24 of the length of material 20; however, one or both of the channels may extend along a shorter distance.

The anchor channel 30 along the first side 26 of the length of material 20 has an anchor-channel interior 34 defined by a first anchor-channel sidewall 36 having a bottom edge 36a, a second anchor-channel sidewall 38 having a bottom edge 38a, and an anchor-channel bottom 40 extending between the bottom edges 36a, 38a (see FIG. 3). It should be noted, however, that the anchor-channel bottom 40 may not directly intersect with the bottom edges 36a, 38a. In this regard, elements may be present between the first and second anchor-channel sidewalls 36, 38 and the anchor-channel bottom 40 in the preferred embodiment. For example, screw bosses 42 are present between the bottom edges 36a, 38a and the anchor-channel bottom 40, as shown in FIG. 3.

Notwithstanding the screw bosses 42, the anchor-channel interior 34 of the preferred cast-in anchor 16 has a generally rectangular cross-section profile with the first and second anchor-channel sidewalls 36, 38 parallel to each other and the anchor-channel bottom 40 orthogonal to the sidewalls 36, 38 throughout the anchor-channel interior 34. However, alternative embodiments of the anchor-channel interior 34 are possible, such as, for example, an anchor-channel interior 34 with a generally triangular cross section profile (not shown), or, anchor-channel sidewalls 36, 38 which are stepped, which have one or more outcroppings, or which are otherwise not flat (not shown). Additionally, first and second anchor-channel sidewalls 36, 38 may not be shaped and sized identical to each other, though they preferably are.

The first and second anchor-channel sidewalls 36, 38 each have, respectively, outer edges 36b, 38b opposite of their bottom edges 36a, 38a. Each outer edge 36b, 38b forms the boundary of the anchor-channel interior 34 along its respective anchor-channel sidewall 36, 38. Extending into the anchor-channel interior 34 from the first anchor-channel sidewall 36 is a first retaining lip 36c and from the second anchor-channel sidewall 38 is a second retaining lip 38c. Preferably, the first and second retaining lips 36c, 38c extend into the anchor-channel interior 34 along the outer edges 36b, 38b of their respective anchor-channel sidewalls 36, 38 but could extend from elsewhere on the sidewalls 36, 38. Additionally, the first and second retaining lips 36c, 38c preferably are present along a significant, longitudinal portion of the anchor channel 30 but could be along a shorter portion, or, alternatively, could even be a series of shorter retaining lips 36c, 38c (not shown).

The first and second retaining lips 36c, 38c extend from their respective anchor-channel sidewalls 36, 38 toward each other. The first retaining lip 36c has a side surface 36d which faces a side surface 38d of the second retaining lip 38c. Between the side surfaces 36d, 38d of the first and second retaining lips 36c, 38c is an opening 44 which exposes the plate-channel interior 34. Additionally, each of the preferred retaining lips 36c, 38c has a lock-interface surface 36e, 38e facing generally toward the anchor-channel bottom 40. Each of the lock-interface surfaces 36e, 38e forms an angle with their respective first and second anchor-channel sidewalls 36, 38. As shown in FIG. 3 angle α₁ is the angle formed between the first anchor-channel sidewall 36 and the lock-interface surface 36e while angle α₂ is the angle formed between the second anchor-channel sidewall 38 and the lock-interface surface 38e. Preferably, both angles α₁, α₂ are acute and are equal to each other, however either, or both, of the angles α₁, α₂ may not be acute and they may not be equal to each other.

In the preferred embodiment of the cast-in anchor 16, the anchor channel 30 has a first entry point 46 and a second entry point 48 at opposite ends 22, 24 of the length of material 20. Entry points 46, 48 are areas of the anchor channel 30 where the first and second retaining lips 36c, 38c have been reduced or eliminated from the first and second anchor-channel sidewalls 36, 38 and are where the bolt-retainer assembly 14 may be inserted into the anchor-channel interior 34. It should be noted, however, that alternative embodiments of the cast-in anchor 16 may not have entry points 46, 48, or, more or less entry points 46, 48 may be present, depending on the size and application of the present invention.

The plate channel 32 is on the second side 28 of the length of material 20 as shown in FIG. 2. The plate channel 32 has a plate-channel interior 50 defined by a first plate-channel sidewall 52 having a bottom edge 52a, a second plate-channel sidewall 54 having a bottom edge 54a, and a plate-channel bottom 56 extending between the bottom edges 52a, 54a (see, FIG. 3). The first and second plate-channel sidewalls 52, 54 each have, respectively, outer edges 52b, 54b opposite of their bottom edges 52a, 54a, and, each outer edge 52b, 54b forms the boundary of the plate-channel interior 50 along its respective plate-channel sidewall 52, 54.

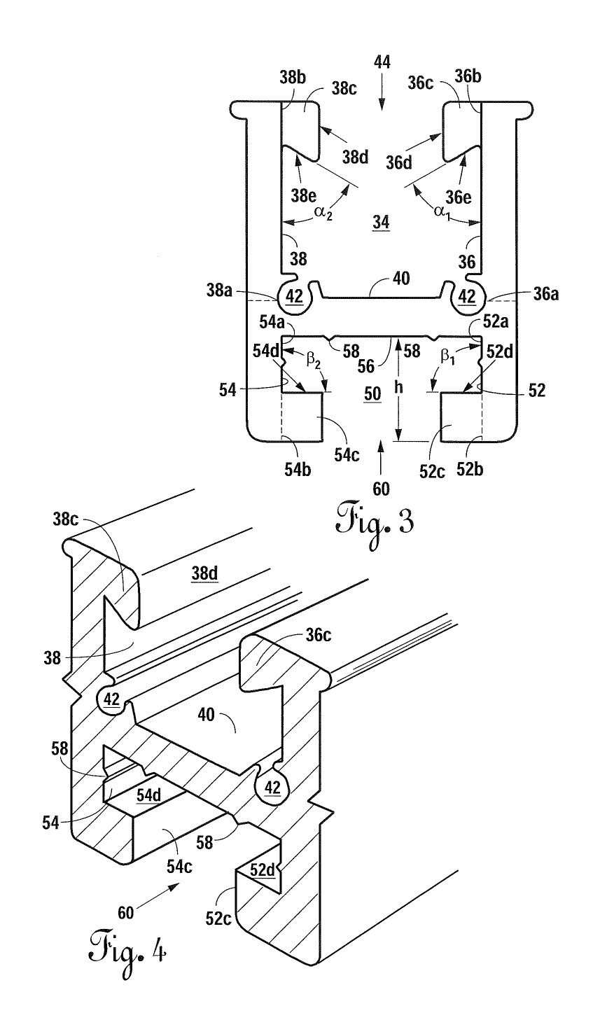

It should be noted that elements may be present along or between the first and second plate-channel sidewalls 52, 54 and the plate-channel bottom 56. In the preferred embodiment, for example, one or more tolerance tabs 58 protrude from the first and second plate-channel sidewalls 52, 54 and from the plate-channel bottom 56 into the plate-channel interior 50 (see, e.g., FIG. 4). When present, the tolerance tabs 58 may extend along the entire length of the plate-channel interior 50 or may be placed at differing intervals therein.

Notwithstanding the tolerance tabs 58, the plate-channel interior 50 of the preferred cast-in anchor 16 has a generally rectangular cross-sectional profile. In this regard, the first and second plate-channel sidewalls 52, 54 are parallel to each other and the plate-channel bottom 56 is orthogonal to the sidewalls 52, 54 throughout the plate-channel interior 50. However, alternative embodiments of the plate-channel interior 50 are possible, such as, for example, a plate-channel interior 50 with a generally triangular cross-sectional profile, or, plate-channel sidewalls 52, 54 which are stepped (not shown). Additionally, first and second plate-channel sidewalls 52, 54 may not be shaped and sized identical to each other, though they preferably are.

A first plate-retaining lip 52c extends from the first plate-channel sidewall 52 into the plate-channel interior 50 and a second plate-retaining lip 54c extends from the second plate-channel sidewall 54 into the plate-channel interior 50 in the preferred embodiment. The first and second plate-retaining lips 52c, 54c extend from their respective plate-channel sidewalls 52, 54 toward each other, leaving an opening 60 which exposes the plate-channel interior 50 between them. Preferably, the first and second plate-retaining lips 52c, 54c extend into the plate-channel interior 50 along the outer edges 52b, 54b of their respective plate-channel sidewalls 52, 54 but could extend from elsewhere on the sidewalls 52, 54. Additionally, the first and second plate-retaining lips 52c, 54c preferably are present along a significant longitudinal portion of the plate channel 32 but could be along a shorter portion, or, alternatively, could even be a series of shorter plate-retaining lips 52c, 54c (not shown).

Each of the preferred plate-retaining lips 52c, 54c has a plate-interface surface 52d, 54d which faces generally toward the plate-channel bottom 56. Each of plate-interface surfaces 52d, 54d forms an angle with its respective plate-channel sidewall 52, 54. As shown in FIG. 3, angle β₁ is the angle formed between the first plate-channel sidewall 52 and the plate-interface surface 52d while angle β₂ is the angle formed between the second plate-channel sidewall 54 and the plate-interface surface 54d. Preferably, both angles β₁, β₂ are right angles however either, or both, of the angles β₁, β₂ may not be a right angle.

The preferred cast-in anchor assembly 12 also has a first endplate 62 attached to the first end 22 of the length of material 20 and a second endplate 64 attached to the second end 24. Attaching the first and second endplates 62, 64 to their respective ends of the length of material 20 may be accomplished by any manner which securely affixes the endplates 62, 64 to the cast-in anchor 16. Preferably, each of the endplates 62, 64 has two assembly holes 66 which align with the screw bosses 42, and, screws 68 threaded through the assembly holes 66 and into the screw bosses 42 (see, eg., FIGS. 10-11, 14) securely attach the endplates 62, 64 in place. Additionally, the first and second endplates 62, 64 each preferably have one or more installation holes 70 (see FIGS. 1 & 2), which may be used in connection with a suitable fastener such as a screw or nail (not shown) to secure the preferred cast-in anchor 16 to the concrete form (not shown) prior to concrete being poured.

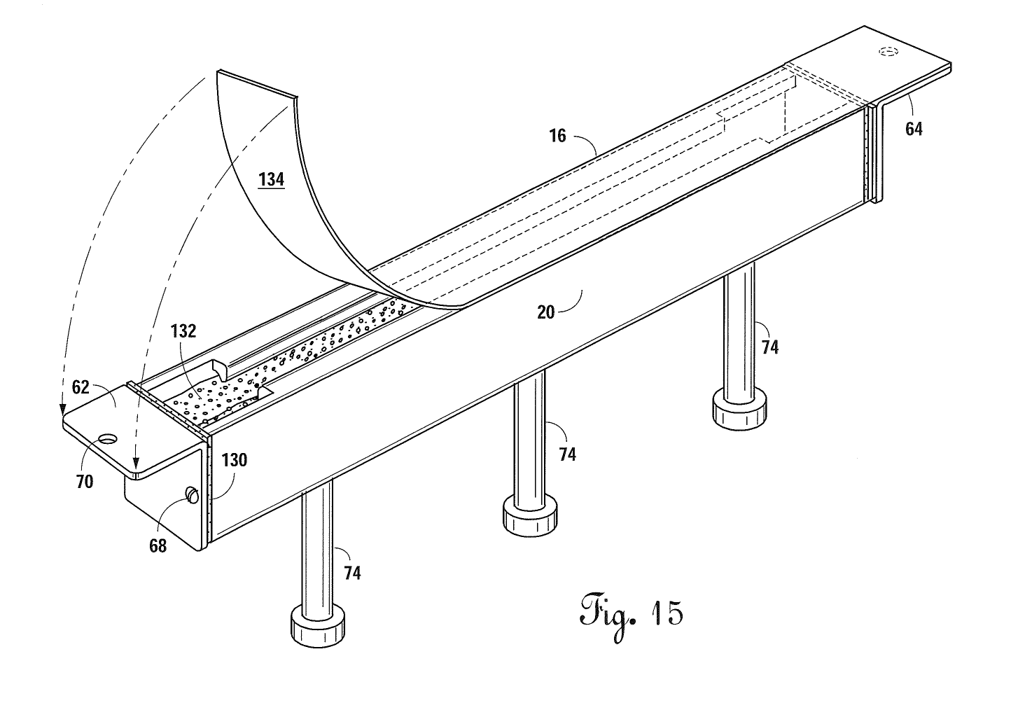

Also shown in FIG. 2 is the base assembly 18 attached to the cast-in anchor 16 to form the cast-in anchor assembly 12. The base assembly 18 has a base plate 72 with one or more headed studs 74 extending from it. The base plate 72 preferably is a rectangular prism (see FIG. 14) which is as long as the plate-channel interior 50 and which is sized to create an interference fit within the preferred plate channel 32; however, base plate 72 can be of virtually any shape or size which at least partially fits within the plate-channel interior 50. As shown, the base plate 72 is entirely within the plate-channel interior 50 between the plate-channel bottom 56 and the first and second plate-retaining lips 52c, 54c. However, a portion of the base plate 72 may be outside the plate-channel interior 36 in alternative embodiments.

In the preferred base assembly 18, each of the one or more headed studs 74 is attached directly to the base plate 72 in the plate-channel interior 50 and extends perpendicularly from the base plate 72 out of the plate-channel interior 50. However, design choice and application may dictate that intermediate elements are present (not shown) between the base plate 72 and the one or more headed studs 74, or, that one or more of the headed studs 74 attaches to the base plate 72 outside of the plate-channel interior 50. Additionally, one or more of the headed studs 74 may extends non-perpendicularly from the base plate 72 or the headed studs 74 may extend at differing angles as compared each other. Similarly, the size and number of headed studs are design choices which may depend on application and configuration of the concrete structure in which the cast-in anchor system 10 is used.

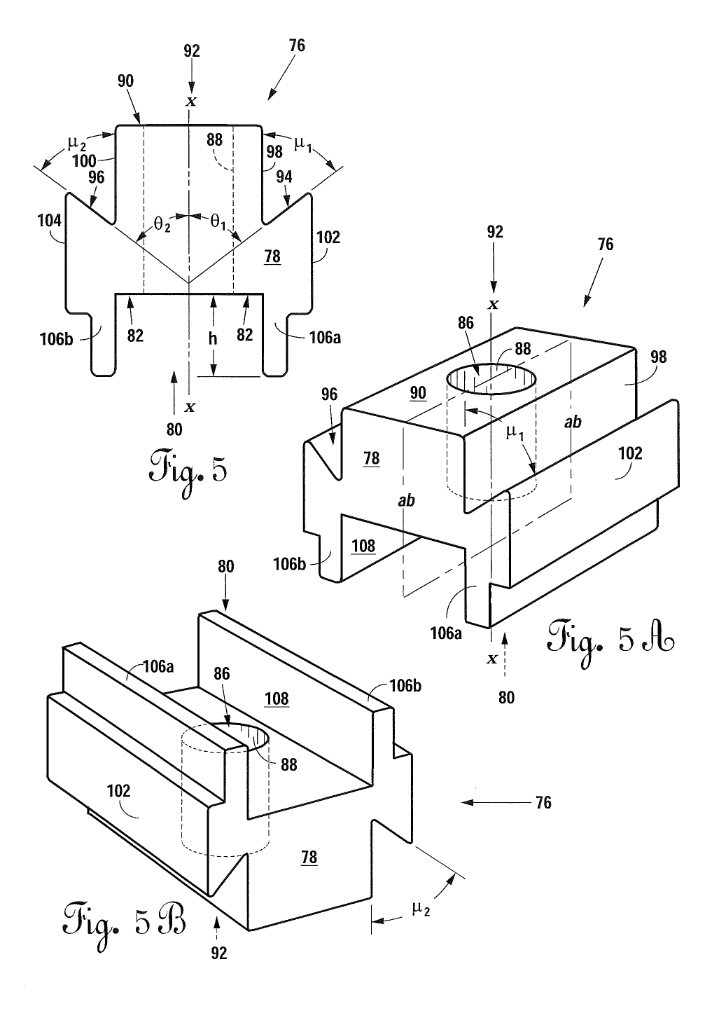

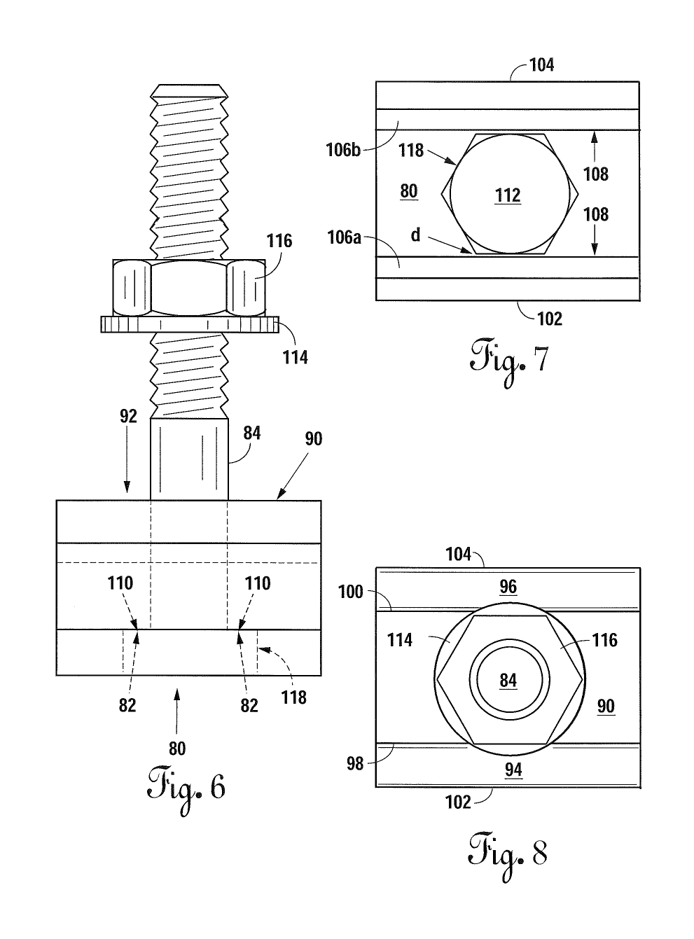

Turning now to FIGS. 5-5B, a bolt retainer 76 for use in the preferred bolt-retainer assembly 14 is shown. The bolt retainer 76 is a rigid body 78 with a first side 80 having bearing surface 82 thereon. As will be seen, bearing surface 82 is the surface on the first side 80 where an industry-standard bolt 84 (see, e.g., FIG. 6) exerts force against the bolt retainer 76 when the bolt-retainer assembly 14 is tightened and its exact configuration depends largely on the bolt 84 which is to be used with the cast-in anchor system 10. For example, with the standard hex head bolt 84 shown, the bearing surface 82 is the planar surface under the head of the bolt-head 112; however, bearing surface 82 could be non-planar such as, for example, if it were a conical surface countersunk into the first side 80 (not shown).

The bearing surface 82 has a bolt-hole 86 through it where the bolt 84 is inserted. The bolt-hole 86 extends through the rigid body 78 along an axis x and is defined by a circumferential wall 88 that circumscribes axis x. The circumferential wall 88 terminates at an outer surface 90 on a second side 92 of the rigid body 78. The outer surface 90 is the surface on the second side 92 of the rigid body 78 which faces the opening 44 of the anchor channel 30 when the bolt retainer 76 is placed therein. Preferably the outer surface 90 is the outermost boundary of the rigid body 78 on the second side 92 though it does not have to be.

The outer surface 90 extends along the second side 92 of the rigid body 78 toward a first lock surface 94 and a second lock surface 96 also on the second side 92 of the rigid body 78. In the preferred embodiment, a first shearwall 98 is disposed between the outer surface 90 and the first lock surface 94 and a second shearwall 100 is disposed between the outer surface 90 and the second lock surface 96. However, first and second shear walls 98, 100 may not be present in alternative embodiments of the invention such as, for example, where the outer surface 90 directly intersects with the first and second lock surfaces 94, 96.

As will be seen, the first and second lock surfaces 94, 96 engage with the first and second retaining lips 36c, 38c to hold the bolt-retainer assembly 14 in the anchor channel 30. Preferably, they are located opposite of each other and are aligned such that the rigid body 78 is bilaterally symmetric about a plane of symmetry ab extended through axis x. The first and second lock surfaces 94, 96 are also preferably a smooth, planar surface, though they could be a toothed or knurled surface (not shown). Regardless of whether they are smooth, however, the general face of the surfaces 94, 96 is at least orthogonal to the axis x of the bolt-hole 86. In this regard, if a plane were extended along the general face of either surface 94, 96 until it intersected axis x, an angle θ formed between axis x and the extended plane would be 90° or less. As shown in FIG. 5, angle θ₁ is between the (extended) first lock surface 94 and axis x and angle θ₂ is between the (extended) second lock surface 96 and axis x. In the preferred embodiment, angles θ₁, θ₂ are acute angles equal to angles α₁, α₂ of the anchor channel 30 (see FIG. 3).

Preferably, the outer surface 90 of the second side 92 is distinguished from the first and second lock surfaces 94, 96 by the first and second shearwalls 98, 100. If so, an angle μ₁ is defined between the first shearwall 98 and the first lock surface 94 and an angle μ₂ is defined between the second shearwall 100 and the second lock surface 96. The first and second shearwalls 98, 100 are preferably parallel to each other and parallel to plane ab, meaning that angles θ₁, θ₂ would be equal to angles μ₁, μ₂. It is contemplated, however, that such a distinction between the outer surface 90 and the two lock surfaces 94, 96 may not be present in alternative embodiments such as, for example, if the entire second side 92 of the rigid body 78 were a single, planar surface (not shown). Moreover, angles θ₁, μ₁, θ₂, & μ₂ may not be equal to each other in alternative embodiments.

A first sidewall 102 and a second sidewall 104 define the boundary of the rigid body 78 between its first side 80 and its second side 92. Preferably, the first and second sidewalls 102, 104 are a single, rectangular, smooth surface aligned in parallel to plane ab through axis x. However, first and second sidewalls 102, 104 may be any shape or configuration which bounds the area of the rigid body 78 between the first side 80 and the second side 92 on their respective ends of the rigid body 78.

On the first side 80 of the rigid body 78 is one or more bolt-lock tabs 106. The bolt-lock tabs 106 have a planar surface 108 parallel to axis x and located a distance d from the bearing surface 82 (see FIG. 7). The planar surface 108 prevents the industry-standard bolt 84 from rotating past a certain point once the bolt 84 is seated within the bolt retainer 76 as discussed in further detail below. Preferably, the planar surface 108 is adjacent the bearing surface 82 and distance d is minimal. In some instances, such as when the planar surface 108 is immediately adjacent the bearing surface, distance d is zero; however, in other instances, distance d may be larger.

The exact shape and configuration of the bolt-lock tabs 106, as well as the number of tabs 106 which are present, may be varied greatly. Preferably, a first bolt-lock tab 106a and a second bolt lock tab 106b extend from the first side 80 of the rigid body 78; however, more or less bolt-lock tabs 106 may be present. If more than one is present, each of the bolt-lock tabs 106 are preferably sized and shaped similar to each other, though they do not have to be. Additionally, the bolt-lock tabs 106 preferably extend from the first side 80 but, in alternative embodiments, could be created by a surface depression (not shown) on the first side 80.

FIGS. 6-8 show the preferred bolt-retainer assembly 14 formed with the industry-standard bolt 84 seated in the bolt retainer 76 of FIGS. 5-5b. As shown in FIG. 6, the bolt 84 is inserted through the bolt-hole 86 until a surface 110 on the bolt 84 contacts the bearing surface 82 on the first side 80 of the bolt retainer 76. In the embodiment shown, the surface 110 is on the underside of a bolt-head 112 at one end of the bolt 84 (see, e.g., FIG. 14). In alternative embodiments, however, the surface 110 may be located elsewhere on the bolt 84 such as, for example, if the surface 110 were a conical surface on the bolt 84 corresponding to a conical bearing surface 82 (not shown). A washer 114 and a nut 116 are also shown on the threaded end of the bolt 84.

As shown in FIG. 7, the bolt-head 112 is between the first and second bolt-lock tabs 106a, 106b when the bolt 84 is seated on the bolt retainer 76. The bolt-head 112 shown in FIG. 7 is a standard hexagonal shape but it could be any number of industry standard shapes, such as, for example, a square bolt-head (not shown). Regardless of its shape, the bolt-head 112 has one or more side surfaces 118 which contact the planar surface 108 of the first and second bolt-lock tabs 106a, 106b when the bolt-head 112 is rotated about axis x in the bolt-hole 86 (not shown). The contact of the one or more side surfaces 118 of the bolt-head 112 prevents the bolt 84 from rotating in the bolt-hole 86 when the nut 116 is torqued to tighten the connection.

FIG. 8 shows the preferred bolt retainer assembly 14 shown in FIG. 6, from a top view. As shown, the outer surface 90 of the bolt retainer 76 faces the washer 114 and the nut 116 on the bolt 84. The first and second lock surfaces 94, 96 are on either side of the outer surface 90 and have a shade line to illustrate that the preferred lock surfaces 94, 96 are angled with respect to the first and second shearwalls 98, 100 as discussed previously.

As shown in FIG. 6-8, the preferred first and second bolt-lock tabs 106a, 106b are sized such that the bolt-head 112 fits entirely within the space between bolt-lock tabs 106a, 106b. In this regard, the first and second bolt-lock tabs 106a, 106b preferably have a height h from the first side 80 of the preferred bolt retainer 76 which is equal to or slightly greater than the height of bolt-head 112. Additionally, both the first and second bolt-lock tabs 106a, 106b of the preferred bolt retainer 76 are longer than the width from corner-to-corner across the bolt-head 112.

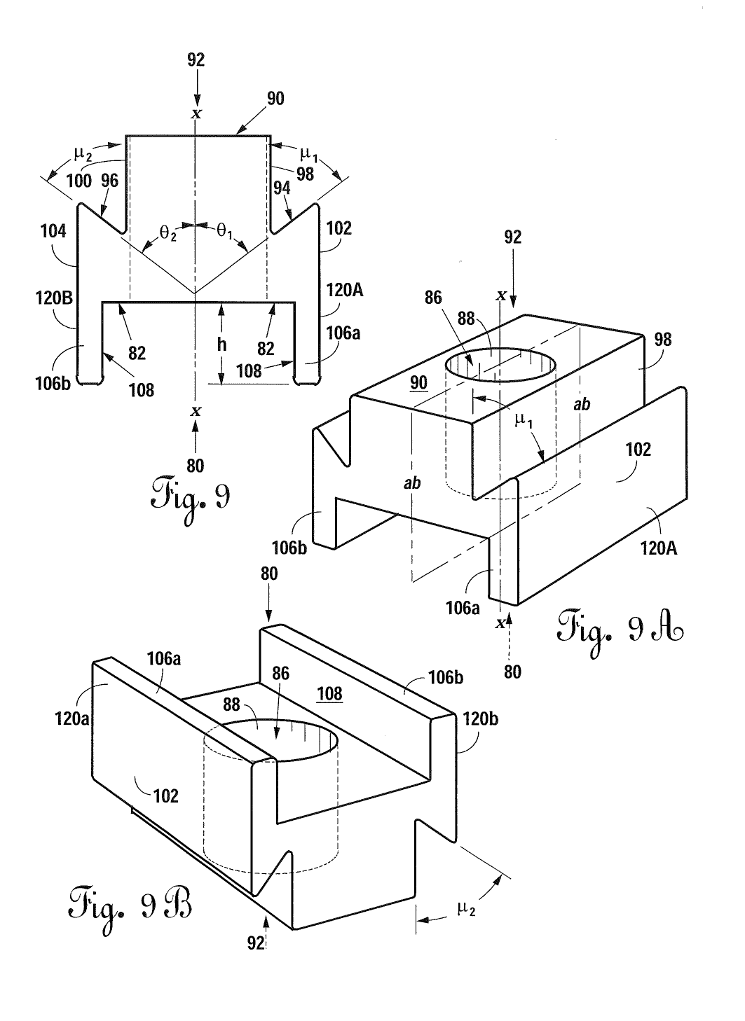

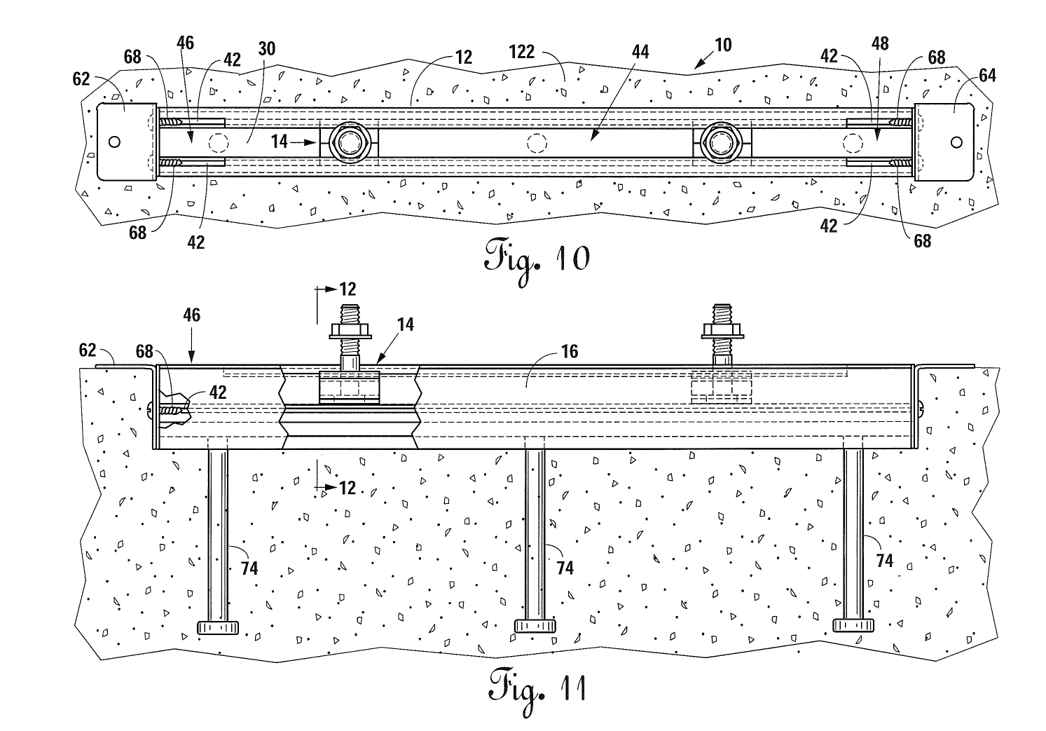

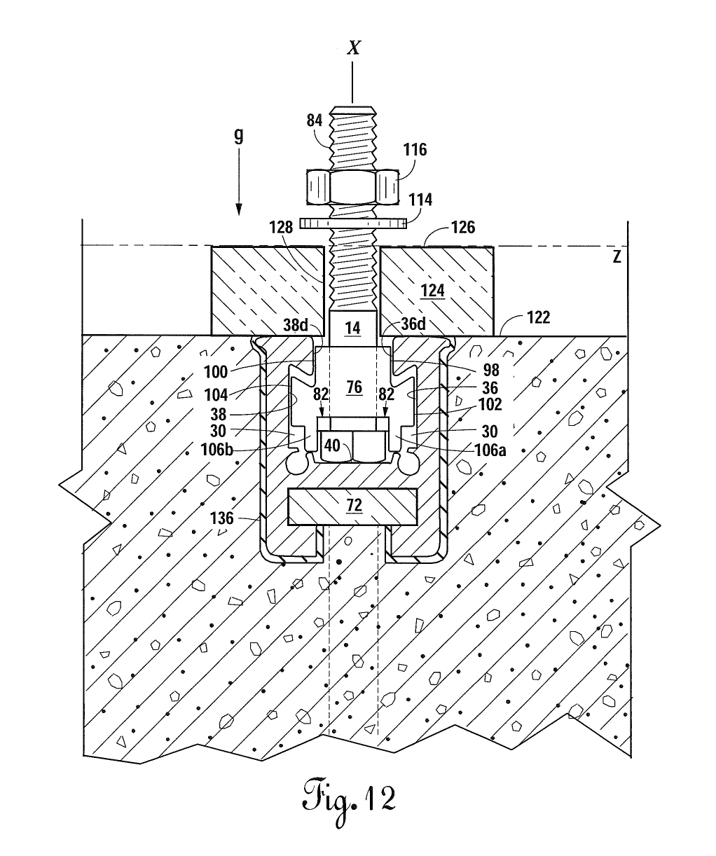

FIGS. 9-9B show an alternative embodiment of the bolt retainer 76. As shown, the first and second bolt-lock tabs 106a, 106b each have an outer wall 120a, 120b, respectively, coinciding with the first and second sidewalls 102, 104 of the rigid body 78. Regardless of the form of the outer walls 120a, 120b, however, the bolt-lock tabs 106a, 106b of the alternative bolt retainer 76 shown in FIGS. 9-9B each have the planar surface 108 which functions in the same manner as the bolt retainer 76 depicted in FIGS. 5-5B.

FIG. 10 shows the cast-in anchor system 10 embedded within the concrete structure and illustrates the cast-in anchor system 10 from the view of a user (not shown) looking at a face 122 of the concrete structure where the opening 44 in the cast-in anchor assembly 12 is exposed. As shown, the bolt-retainer assemblies 14 have been positioned in the anchor channel 30 a longitudinal distance from the first and second entry points 46, 48. Positioning the bolt-retainer assemblies 14 at their desired location in the anchor channel 30 may be achieved by manually displacing the bolt-retainer assemblies 14 along the length of the anchor channel 30, after the bolt-retainer assembly 14 has been placed into the anchor-channel interior 34 through one of the entry points 46, 48.

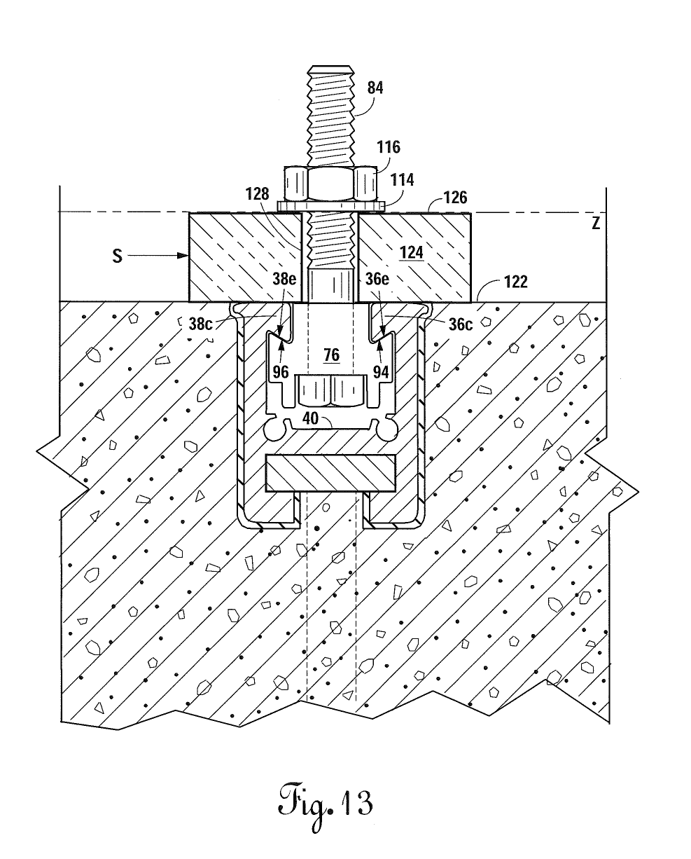

FIG. 11 shows the cast-in anchor system 10 embedded within the concrete from a side view, illustrating the headed studs 74 extending into the concrete structure. The cast-in anchor 16 has a portion cut away to show the location of the bolt-retainer assembly 14 relative to the first entry point 46. Additionally, another portion of the cast-in anchor 16 is cut away to illustrate the attachment of the first endplate 62 to the cast-in anchor 16. In this regard, one of the screws 68 is threaded into one of the screw bosses 42. FIG. 10 also shows the screws 68 attaching the first and second endplates 62, 64 to the cast-in anchor 16, as they can be seen through the first and second entry points 46, 48 of the anchor channel 30.

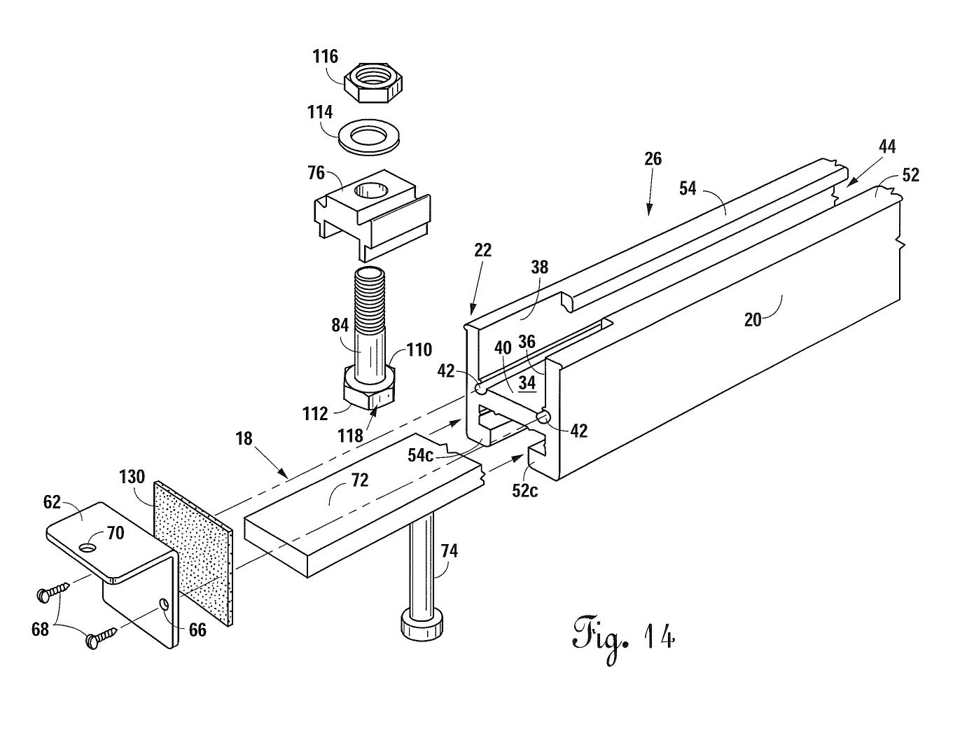

FIGS. 12-13 show a cross section of the embedded cast-in anchor system 10 taken along section line 12-12 in FIG. 11, but, a workpiece 124 with a face 126 along line z has been added. The workpiece 124 presents an example of an object upon which the present cast-in anchor system 10 may be used. The bolt 84 is placed within a hole 128 on the workpiece 124 and the washer 114 and nut 116 are threaded onto the bolt 84. FIG. 12 shows the cast-in anchor system 10 prior to tightening its connection with the workpiece 124 and, accordingly, the washer 114 and nut 116 are not exerting force on the face 126 of the workpiece 124. FIG. 13, however, shows the connection after it has been tightened with the nut 116 exerting force against the washer 114 and resultantly causing the washer 114 to exert force against the face 126 of the workpiece 124.

Prior to tightening the connection, the preferred bolt-retainer assembly 14 rests in the preferred anchor channel 30 in a manner dependent on the orientation of the cast-in anchor system 10 in the concrete structure. In FIG. 12, the cast-in anchor system 10 is oriented such that gravitational force g causes the bolt-retainer assembly 14 to rest against the anchor-channel bottom 40. With the preferred bolt retainer 76 having the preferred sized bolt-lock tabs 106a, 106b, the bolt 84 is limited in the amount of axial displacement it can undergo along axis x between the bearing surface 82 of the bolt retainer 76 and the anchor-channel bottom 40.

Additionally, the width of the bolt retainer 76 across the anchor-channel interior 34 and its fit within the anchor-channel interior 34 limits the amount of lateral displacement the bolt-retainer assembly 14 can travel between the first and second anchor-channel sidewalls 36, 38 of the anchor channel 30. In this regard, the bolt retainer 76 is preferably sized such that its first sidewall 102 contacts the first anchor-channel sidewall 36 or its second sidewall 104 contacts the second anchor-channel sidewall 38 after minimal lateral displacement. Adding to the limited lateral displacement of the preferred bolt retainer 76 is contact of the first and second shearwalls 98, 100 with the side surfaces 36d, 38d of the first and second retaining lips 38c, 38d.

Minimizing the amount of lateral and axial displacement of the bolt-retainer assembly 14 allows less awkward operation in the preferred cast-in anchor system 10. For example, in the orientation shown in FIG. 12 the user does not have to apply an initial force against the bolt-retainer assembly 14 to hold it in place because the bolt-retainer assembly 14 rests against the anchor-channel bottom 40. Accordingly, the user may remove his/her hands from the bolt-retainer assembly 14 and use his/her hands to place the workpiece 124 over the bolt 84 and install the washer 114 and the nut 116. As another example, if the preferred cast-in anchor system 10 were oriented such that gravitational force caused the first or second sidewall 102, 104 of the bolt retainer 76 to rest against the first or second anchor-channel sidewall 36, 38 of the anchor channel 30 (not shown), the user could remove his/her hands from the bolt-retainer assembly 14 and it would remain stable.

As noted, FIG. 13 shows a tightened connection of the cast-in anchor system 10 and the workpiece 124. When the connection is tightened, the bolt 84 is pulled in a direction away from the anchor-channel bottom 40 causing the surface 110 (see FIG. 14) to exert force against the bearing surface 82 of the bolt retainer 76. As a result, the bolt retainer 76 is displaced in a direction away from the anchor-channel bottom 40 until it engages with the first and second retaining lips 36c, 38c. In this regard, the first and second lock surfaces 94, 96 of the bolt retainer 76 exert force against the lock-interface surfaces 36e, 38e of the first and second retaining lips 36c, 38c and the bolt-retainer assembly 14 is prevented from exiting the anchor-channel 30.

The preferred cast-in anchor system 10 also protects against shear force which may be applied to the workpiece 124. In this regard, first and second shearwalls 98, 100 of the bolt retainer 76 are adjacent, respectively, the side surfaces 36d, 38d of the first and second retaining lips 36c, 38c of the anchor channel 30. A shear force s applied to the workpiece 124 shown in FIG. 13 will create a resulting shear force against the bolt 84 (not shown). The resulting shear force against the bolt 84 will then transfer to the bolt retainer 76 causing the first shearwall 98 to exert a resulting force against the side surface 36d of the first retaining lip 36c, which is absorbed into the concrete structure through the cast-in anchor assembly 12. In a similar manner, a resulting force would be exerted by the second shearwall 100 of the bolt retainer 76 against the side surface 38d of the second retaining lip 38c if shear force s were directed in the opposite direction.

As mentioned, the present invention contemplates various components of the cast-in anchor system 10 being manufactured through extrusion processes. Extrusion is a well-known process which creates a fixed, cross-sectional profile shape for a variety of materials. Pushing or pulling the raw material though a die (not shown) forms the fixed, cross-sectional profile. The exact manner of moving the raw material through the die, as well as the specific manufacturing processes thereafter, vary greatly, often depending upon the particular material being extruded and the desired structural properties of the material. Accordingly, “extrusion” or “extruding” as used herein refers to the process of forcing the material through a die rather than the various manufacturing or finishing process which may occur thereafter.

The preferred cast-in anchor 16 and preferred bolt retainer 76 are extruded from a structural aluminum alloy, such as, for example 6005-T5, 6061-T6, or 6005A-T6. Preferably, aluminum alloy 6005A-T6 is utilized due to its superior corrosion and structural properties. The specific manufacturing processes discussed herein have been found suitable to apply to the preferred alloy.

To begin the process, a die (not shown) is selected according to the desired profile shape of the cast-in anchor 16 or the desired profile shape of the bolt retainer 76 which is to be produced. The die is heated to approximately 800° Fahrenheit, which prevents the aluminum alloy from sticking to the die as the alloy is passed through it. The raw, non-extruded aluminum alloy comes in the form of a billet (not shown). The billet is heated to approximately 1000°Fahrenheit and a press (not shown) pushes the heated billet through the heated die to extrude the material.

As the aluminum alloy exits the die, it is a long length of the material, perhaps seventy-five (75) to one hundred (100) feet long, with the selected uniform profile along the entire length. As for the cast-in anchor 16, the various elements discussed above are present along the entire long length of material. For example, the screw bosses 42 and the first and second retaining lips 36c, 38c of the anchor channel 30 are formed by the die and extend along the entire long length of material. Likewise for the first and second plate-retaining lips 52c, 54c as well as the tolerance tabs 58. Similarly, the various elements of the bolt retainer 76, such as the first and second lock surfaces 94, 96 and the first and second bolt-lock tabs 106a, 106b, are formed as the material passes through the die and extend along the entire long length of material.

After exiting the die, the long length of material is quenched using water or fans (not shown) and moved to a cooling table (not shown). The long length of material remains on the cooling table for approximately twenty-five (25) to thirty (30) minutes, or longer, depending on the desired temperature. The now-cooled long length of material is stretched to straighten it and cut into smaller sections (not shown) so the material can be placed in a tempering oven. The length of the smaller sections depends on weight of the extruded material per foot and the capacity of the tempering oven. For example, the smaller sections may be twelve (12) to twenty-five (25) feet long. The smaller sections are then moved to the tempering oven, where they are heated to and remain at 345° Fahrenheit for approximately eight (8) hours to achieve a T6 temper.

After the smaller sections of the extruded material achieve the desired temper, they are removed from the tempering oven and allowed to air cool. Once cooled, the smaller sections are ready to be cut into the length of material 20 which forms the cast-in anchor 16 or cut into a desired length of the rigid body 78 for the bolt retainer 76. The length of material 20 may be any number of lengths, such as, for example, twelve (12), eighteen (18), or twenty-four (24) inches, depending on the application of the cast-in anchor system 10. Additionally, the rigid body 78 may be any desired length, but, it has been found that a length of 1.25 inches to 1.5 inches is suitable.

After being cut to the desired lengths, the length of material 20 and the bolt retainer 76 undergo additional manufacturing processes to attain their final shape. These processes may be manually implemented or may be automated. For example, the bolt-hole 86 may be punched or drilled into the bolt retainer 76 according the dimensions of the industry-standard bolt 84 which is to be used. In this regard, a bolt-hole 86 having a diameter 0.031 inches greater than the diameter of the bolt 84 has been found acceptable. As for the length of material 20, portions of the first and second retaining lips 36c, 38c are grinded or routed out to form the first and second entry points 46, 48 near the first and second ends 22, 24 of the length of material 20.

Once the bolt retainer 76 is in its final shape, it may undergo additional finishing processes to increase its corrosion resistance, depending on the intended application of the cast-in anchor system 10. For example, the bolt retainer 76 may be left with a mill finish if the cast-in anchor system 10 is to be used in a non-corrosive environment. In contrast, it may undergo a corrosion treatment to protect it if the cast-in anchor system 10 is to be used in a corrosive environment. Examples of corrosion treatments include a two-component corrosion treatment system known as “EK-100” manufactured by Blue River Coatings or a flouropolymer coating known as “FlouroKote#1” manufactured by Metal Coatings Corporation. As another example, the bolt retainer 76 may be anodized or polyvinyl chloride electrical tape may be applied between the bolt 84 and the bolt retainer 76 to help prevent corrosion.

The cast-in anchor 16 preferably undergoes a corrosion treatment regardless of the application of the cast-in anchor system 10. Corrosion treatment on the cast-in anchor 16 is designed to prevent a galvanic reaction from occurring between the preferably aluminum alloy cast-in anchor 16 and the preferably steel base plate 72. To that end, the cast-in anchor 16 should be processed or coated to prevent direct contact with the base plate 72. Though various processes may be used, one that has been found to be successful is applying a Type-III anodized finish per the MIL-A-8625F specification. However, other types of anodizing or other types of coating may prove to be successful.

The preferred base assembly 18 also undergoes a corrosion treatment to prevent a galvanic reaction from occurring. As previously indicated, the preferred base assembly 18 preferably is made from steel. The base plate 72 is made from high-strength steel such as, for example, ASTM A572 Grade 50, while the headed studs 74 may be made from alloy steel such as, for example, per ASTM Standard A29 or A496. The one or more headed studs 74 are welded to the base plate 72 and the entire base assembly 18 is hot dip galvanized, preferably, according to ASTM Standard A123, after the weld ferrules debris is cleaned.

The base assembly 18 is now ready to be attached to the cast-in anchor 16 to form the cast-in anchor assembly 12. As shown in FIG. 14, the base plate 72 of the base assembly 18 is inserted into the plate-channel interior 50 of the cast-in anchor 16 from the first end 22 of the length of material 20 or, alternatively, from the second end 24 of the length of material 20. The base plate 72 may be manually inserted by hammering it into place or with a machine such as an arbor press (not shown). Prior to insertion, however, the first and second plate-channel sidewalls 52, 54 and their respective plate-retaining lips 52c, 54c, as well as the plate-channel bottom 56, are preferably sprayed with a zinc-rich cold galvanizing compound (not shown) to lubricate the insertion and to add further protection against a galvanic reaction.

In the preferred embodiment, the base plate 72 inserts into the plate-channel interior 50 between the plate-interface surfaces 52d, 54d of the first and second plate-retaining lips 52c, 54c and the plate-channel bottom 56. During insertion, the tolerance tabs 58, or a portion thereof, are sheared off (not shown), thereby creating an interference fit of the base plate 72 in the plate channel 32. Additionally, the one or more headed studs 74 of the base assembly 18 are displaced longitudinally through the opening 60 of the plate channel 32 between the first and second plate-retaining lips 52c, 54c while the base plate 72 is inserted.

The first and second endplates 62, 64 may be attached once the base plate 72 is inserted into the plate-channel interior 50. Preferably, the first and second endplates 62, 64 are pre-galvanized steel which has been stamped out and bent to a desired shape during the manufacturing process. Similarly, the assembly holes 66 and the installation holes 70 may also be stamped out or they may be drilled. To prevent galvanic corrosion from occurring between the preferred length of material 20 and the preferred endplates 62, 64, a seal 130 may be placed between the length of material 20 and the first and second endplates 62, 64, as shown in FIG. 14. Seal 130 may be any material which prevents electrical contact between the length of material 20 and the first and second endplates 62, 64. For example, a closed-cell polyethelene foam glazing tape from C.R. Laurence Company, Inc. has been shown to be successful.

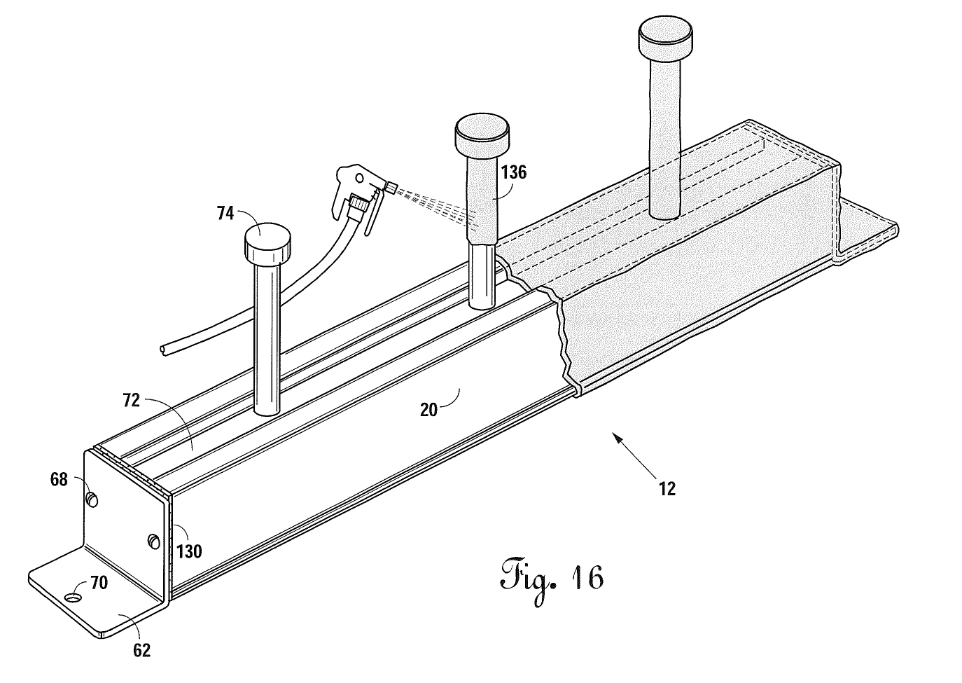

Referring now to FIG. 15, a foam material 132 may be inserted into the anchor channel 30 opening 44 and placed within the open space of the anchor-channel interior 34 after the first and second endplates 62, 64 are attached. Additionally, a length of tape 134 may be placed on the face of the cast-in anchor 16 which will ultimately be exposed after the cast-in anchor assembly 12 is embedded within the concrete structure. The tape 134 preferably extends from the first endplate 62 to the second endplate 64. Both the tape 134 and the foam material 132 help protect against unwanted concrete from seeping into the anchor-channel interior 34 while the concrete is wet.

With the tape 134 in place, the cast-in anchor assembly 12 is ready to receive a water-repellent surface coating 136 on the non-taped surfaces, as shown in FIG. 16. The coating 136 provides an additional protective measure against galvanic corrosion because it helps provide a barrier against water from contacting the metallic portions of the cast-in anchor assembly 12. Water acts as an electrolyte to promote galvanic corrosion and is present in wet concrete. Therefore, applying the coating 134 to the non-taped portions of the cast-in anchor assembly 12 will help protect against galvanic corrosion while the concrete structure cures (see, e.g., FIGS. 12 & 13). Additionally, the coating 136 prevents electrical contact from occurring between the cast-in anchor 16 and any reinforcing steel which may be present in the concrete structure. One such water-repellent surface coating which has been found to be satisfactory is “Bituminous Coating” offered by C.R. Laurence Company, Inc.

Although the present invention has been described with reference to specific embodiments, this description is not meant to be construed in a limiting sense. Various modifications of the disclosed embodiments, as well as alternative embodiments of the invention will become apparent to persons skilled in the art upon the reference to the above-description of the invention. It is, therefore, contemplated that the appended claims will cover such modifications that fall within the scope of the invention.

1. A cast-in anchor assembly comprising a cast-in anchor attached to a base assembly, said cast-in anchor comprising:
a length of material with a first end and a second end, said length of material having an anchor channel disposed at least partially along a first side of said material and a plate channel disposed at least partially along a second side of said material;
said anchor channel comprising:
a first anchor-channel sidewall with an outer edge and a bottom edge opposite said outer edge;
a second anchor-channel sidewall with an outer edge and a bottom edge opposite said outer edge;
an anchor-channel bottom between the bottom edge of said first anchor-channel sidewall and the bottom edge of said second anchor-channel sidewall, said first anchor-channel sidewall, said second anchor-channel sidewall, and said anchor-channel bottom defining an anchor-channel interior;
a first retaining lip extending from said first anchor-channel sidewall into said anchor-channel interior; and,
a second retaining lip extending from said second anchor-channel sidewall into said anchor-channel interior;
said plate channel comprising:
a first plate-channel sidewall with an outer edge and a bottom edge opposite said outer edge;
a second plate-channel sidewall with an outer edge and a bottom edge opposite said outer edge;
a plate-channel bottom between the bottom edge of said first plate-channel sidewall and the bottom edge of said second plate-channel sidewall, said first plate-channel sidewall, said second plate-channel sidewall, and said plate-channel bottom defining a plate-channel interior;
and, wherein said base assembly comprises a base plate at least partially within said plate-channel interior and at least one headed stud at least partially outside of said plate-channel interior.

2. The cast-in anchor assembly of claim 1 wherein said plate channel comprises a first plate-retaining lip extending from said first plate-channel sidewall into said plate-channel interior and a second plate-retaining lip extending from said second plate-channel sidewall into said plate-channel interior.

3. The cast-in anchor assembly of claim 1 wherein said at least one headed stud is attached directly to said base plate.

4. The cast-in anchor assembly of claim 1 wherein said at least one headed stud attaches to said base plate outside of said plate-channel interior.

5. The cast-in anchor assembly of claim 1 wherein the first side of said length of material is opposite of the second side of said length of material.

6. The cast-in anchor assembly of claim 1 wherein said anchor channel and said plate channel each extend from the first end of said length of material to the second end of said length of material and wherein said cast-in anchor assembly comprises a first endplate attached to said first end of said length material and a second endplate attached to said second end of said length of material.

7. The cast-in anchor assembly of claim 6 comprising a seal between each of said end plates and said length of material.

8. The cast-in anchor assembly of claim 1 wherein said length of material is extruded.

9. The cast-in anchor assembly of claim 1 wherein said first retaining lip extends from the outer edge of said first anchor-channel sidewall and said second retaining lip extends from the outer edge of said second anchor-channel sidewall.

10. A bolt retainer comprising:
a rigid body with a bearing surface on a first side;
a bolt-hole in said bearing surface, said bolt-hole being defined by a circumferential wall circumscribing an axis and extending through said rigid body along said axis, said bolt-hole terminating at an outer surface on a second side of said rigid body;
a first bolt-lock tab on the first side of said rigid body, said first bolt-lock tab having a planar surface substantially parallel to the axis of said bolt-hole;
a first lock surface and a second lock surface each disposed on the second side of said rigid body, each of said lock surfaces being at least orthogonal with respect to the axis of said bolt-hole; and,
a first sidewall and a second sidewall each extending from the second side of said rigid body to the first side of said rigid body.

11. The bolt retainer of claim 10 wherein said first bolt-lock tab extends from the first side of said rigid body.

12. The bolt retainer of claim 11 comprising a second bolt-lock tab extending from the first side of said rigid body, said second bolt-lock tab having a planar surface substantially parallel to said axis of said bolt-hole.

13. The bolt retainer of claim 12 wherein said planar surface of said second bolt-lock tab is substantially parallel to said planar surface of said first bolt-lock tab.

14. The bolt retainer of claim 13 wherein said bolt retainer is bilaterally symmetric about a plane of symmetry extending through the axis of said bolt-hole.

15. The bolt retainer of claim 10 comprising a first shearwall and second shearwall disposed on the second side of said rigid body, said first shearwall being between said outer surface and said first lock surface and said second shearwall being between the outer surface and said second lock surface.

16. The bolt retainer of claim 15 wherein each of said shearwalls is parallel to the axis of the bolt-hole.

17. The bolt retainer of claim 10 wherein said bearing surface is planar.

18. The bolt retainer of claim 17 wherein said planar surface of said bolt-lock tab is adjacent said bearing surface.

19. A cast-in anchor system comprising:
a cast-in anchor with an anchor channel disposed on a first side and a plate channel disposed on a second side, said anchor channel comprising:
a first anchor-channel sidewall and a second anchor-channel sidewall with an anchor-channel interior between said first and second anchor-channel sidewalls;
a first retaining lip extending from said first anchor-channel sidewall into the anchor-channel interior and a second retaining lip extending from said second anchor-channel sidewall into the anchor-channel interior;
an opening between said first and second retaining lips;
a base assembly attached to said cast-in anchor, said base assembly comprising a base plate at least partially within a plate-channel interior of said plate channel and at least one headed stud at least partially outside of said plate-channel interior; and,
a bolt retainer insertable into said anchor channel, said bolt retainer comprising:
a rigid body with a bearing surface on a first side, said first side facing away from said opening of said anchor channel after said bolt retainer is inserted therein;
a bolt-hole in said bearing surface, said bolt-hole being defined by a circumferential wall circumscribing an axis and extending through said rigid body along said axis, said bolt-hole terminating at an outer surface on a second side of said rigid body, said outer surface facing toward the opening of said anchor channel after said bolt retainer is inserted therein;
a first bolt-lock tab on the first side of said rigid body, said first bolt-lock tab having a planar surface substantially parallel to the axis of said bolt-hole;
a first lock surface disposed on the second side of said rigid body, said first lock surface being configured to engage a lock-interface surface of said first retaining lip;
a second lock surface disposed on the second side of said rigid body, said second lock surface being configured to engage a lock-interface surface of said second retaining lip; and,
a first sidewall and a second sidewall each extending from the second side of said rigid body to the first side of said rigid body.

20. The cast-in anchor system of claim 19 wherein said bolt retainer comprises a first shearwall and second shearwall disposed on the second side of said rigid body, said first shearwall being between said outer surface and said first lock surface and said second shearwall being between the outer surface and said second lock surface, and, wherein said first shearwall is adjacent at least a portion of a side surface of said first retaining lip after said bolt retainer is inserted into said anchor channel and said second shearwall is adjacent at least a portion of a side surface of said second retaining lip after said bolt retainer is inserted into said anchor channel.

21. The cast-in anchor system of claim 19 wherein said first and second anchor-channel sidewalls of said cast-in anchor are substantially parallel to each other and said first and second sidewalls of said bolt retainer each have a surface substantially parallel to said first and second anchor-channel sidewalls.

22. A method of manufacturing a cast-in anchor assembly comprising:
forming a length of material with an anchor channel disposed along a first side and a plate channel having a plate-channel interior disposed on a second side, said length of material having a first end and at a second end opposite said first end;
attaching at least one headed stud to a base plate, said base plate being sized to fit at least partially within said plate channel interior of plate channel;
inserting said base plate into said plate-channel interior with at least portion of said at least one headed stud being outside said plate-channel interior to form a cast-in anchor assembly; and
applying a water-repellant coating to at least a portion of said cast-in anchor assembly.

23. The method as recited in claim 22 comprising attaching a first endplate to the first end of said length of material and a second endplate to the second end of said length of material.

24. The method as recited in claim 22 comprising removing at least a portion of at least one tolerance tab located within said plate-channel interior.
